(19) United States
(12) Patent Application Publication
(10) Pub. No.: US 2026/0247273 A1
(43) Pub. Date: Aug. 20, 2026

(54) QUALITY OF SERVICE-AWARE PACKET DISTRIBUTION IN USER PLANE FUNCTIONS WITH MULTIPLE WORKER NODES

(71) Applicant: VERIZON PATENT AND LICENSING INC., Basking Ridge, NJ (US)

(72) Inventors: Peretz FEDER, Englewood, NJ (US); Chin CHIU, Allen, TX (US); Ravikumar PATTABIRAMAN, Hillsborough, NJ (US); Ankur BHARADWAJ, New Delhi (IN); Sanjay Charanlal BISEN, Gurgaon (IN)

(73) Assignee: VERIZON PATENT AND LICENSING INC., Basking Ridge, NJ (US)

(21) Appl. No.: 19/058,273

(22) Filed: Feb. 20, 2025

(51) Int. Cl. H04W 48/20; H04W 28/02; H04W 28/24

(52) U.S. Cl. CPC H04W 48/20; H04W 28/0268; H04W 28/24

(57) ABSTRACT

A method and system are disclosed for packet processing in network functions such as a user plane function (UPF) or centralized unit user plane (CU-UP) having multiple worker nodes. A processor receives a packet at the network function and extracts a UE identifier and a priority value from the packet. The processor selects a priority queue from multiple priority queues based on the priority value. A hash value is generated using at least the UE identifier and optionally and the priority value. The processor then selects a worker node from multiple worker nodes based on the hash value and processes the packet at the worker node. The system maintains consistent UE-to-worker mapping while enabling priority-based packet processing and ensuring Service Level Agreement (SLA) requirements are met across flows. This approach enables efficient resource utilization across multiple worker nodes while preserving QoS requirements for different network slices and service flows.

### BACKGROUND

In mobile telecommunications networks, the User Plane Function (UPF) plays a central role in packet processing and forwarding within the 5G core network. The UPF handles user data traffic between the Radio Access Network (RAN) and external data networks, processing both uplink traffic from user equipment (UE) and downlink traffic from data networks.

### BRIEF DESCRIPTION OF THE DRAWINGS

FIG. 1 is a block diagram illustrating a system architecture for prioritized packet processing in a cellular network according to some of the disclosed embodiments.

FIG. 2 is a block diagram illustrating packet structures and hash computation inputs according to some of the disclosed embodiments.

FIG. 3 is a flow diagram illustrating a method for prioritized packet processing and worker node assignment according to some of the disclosed embodiments.

FIG. 4 is a flow diagram illustrating a method for processing packets in a network slicing environment according to some of the disclosed embodiments.

FIG. 5 is a block diagram of a computing device according to some embodiments of the disclosure.

### DETAILED DESCRIPTION

Traditional UPF implementations utilize Receive Side Scaling (RSS) to distribute incoming packets across multiple processing units. RSS typically operates by calculating a hash value based on packet header fields such as source IP address, destination IP address, source port, destination port, and protocol. This hash value is then used to assign packets to specific processing units in a consistent manner.

In 5G networks, traffic arrives at the UPF through different interfaces. For example, the N3 interface handles traffic from the RAN while the N6 interface for traffic from external data networks. Traffic on the N3 interface is encapsulated using the GPRS Tunneling Protocol User Plane (GTP-U), which adds an outer header to the original packet. The UPF must process this traffic according to Quality of Service (QoS) requirements specified by 5G QoS Identifier (5QI) values for uplink traffic and Differentiated Services Code Point (DSCP) markings for downlink traffic.

Network slicing is another feature of 5G networks, allowing operators to create virtual network partitions with different characteristics and quality of service levels. Each network slice may have different requirements for packet processing and resource allocation.

However, existing RSS implementations face several technical challenges in mobile networks (e.g., 5G, 6G, etc.). First, using traditional RSS on GTP-U encapsulated traffic results in poor distribution of packets across UPF's worker nodes since all packets from a given gNodeB share the same outer source IP address. Second, standard RSS algorithms do not account for QoS priorities when distributing packets, potentially leading to suboptimal resource utilization. Third, in scenarios involving multiple worker nodes (whether due to virtualization of network functions and RAN components, horizontal scaling of physical processing resources, or other causes), when these multiple worker nodes process packets for the same UE, a UE bandwidth limit cannot be properly enforced since each worker node has only a partial view of the UE's traffic.

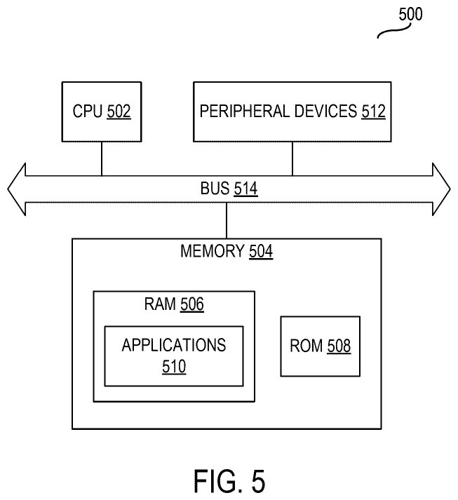

Worker nodes, as used herein, can be implemented through various approaches depending on deployment requirements. In some implementations, worker nodes comprise virtual machines or containers running on general-purpose processors, particularly in deployments utilizing network function virtualization (NFV). In other implementations, worker nodes may be implemented as dedicated hardware processing units, such as specialized network processors or FPGAs. The system supports both virtualized and physical worker node implementations, enabling flexible deployment options while maintaining consistent packet processing capabilities. In some implementations, a worker node can comprise a CPU and related components as described more fully in FIG. 5.

The disclosed embodiments provide methods and systems for QoS-aware packet distribution in UPFs with multiple worker nodes. A UPF receives packets and extracts both UE identification and priority information. This information is used in a two-stage process, first selecting an appropriate priority queue, then generating a modified RSS hash value that incorporates both UE identity and priority information. The hash value is used to select a single worker node that will process all packets for that UE, ensuring consistent handling of UE traffic while maintaining QoS requirements.

When handling network slices, the system maintains slice isolation by incorporating slice-specific requirements into the packet processing pipeline. Each slice may define its own priority schemes and resource allocation policies, which are enforced consistently across the worker nodes processing traffic for that slice. The approach described herein solves the identified problems in several ways. The use of inner UE IP addresses for RSS calculations ensures proper traffic distribution despite GTP-U encapsulation. The two-stage processing approach enables QoS-aware packet handling while maintaining processing efficiency. By ensuring all traffic for a given UE is processed by the same worker node, the system enables proper enforcement of bandwidth limits and other policies. The solution scales efficiently as additional worker nodes can be added while maintaining consistent UE-to-worker mapping and QoS priorities.

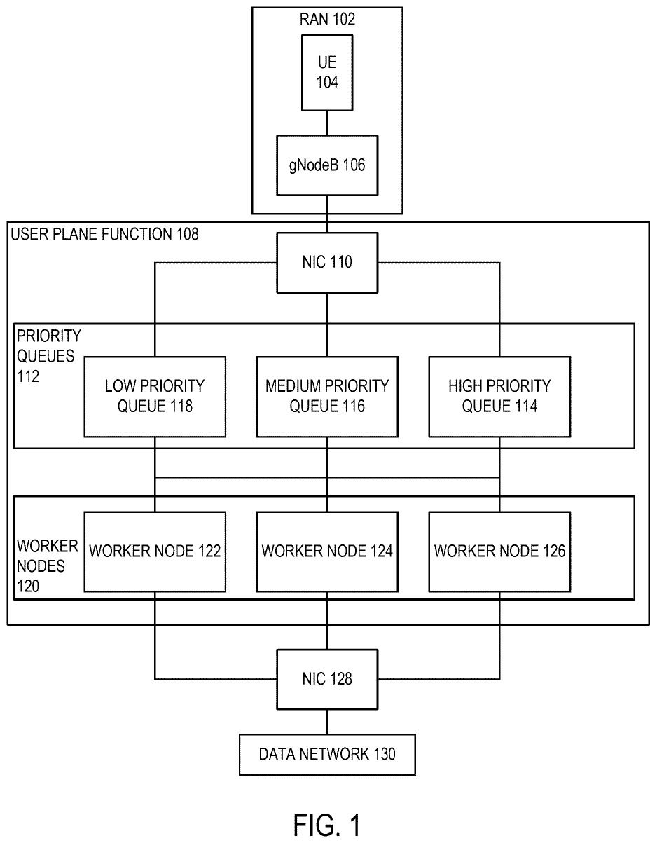

FIG. 1 is a block diagram illustrating a system architecture for prioritized packet processing in a cellular network according to some of the disclosed embodiments.

In the illustrated embodiment, the system can include a RAN 102 communicatively coupled to a UPF 108, which can be in turn connected to a data network 130. Within the RAN 102, a UE 104 can communicate with a gNodeB 106. The gNodeB 106 can serve as the radio interface between the UE 104 and the core network components. In some implementations, multiple UEs can be simultaneously connected to the gNodeB 106, each potentially running multiple applications with different QoS requirements and priorities.

The UPF 108 can include multiple components for processing network traffic. At its ingress, a network interface card (NIC) 110 can receive uplink traffic from the gNodeB 106 over an N3 interface. In some implementations, this traffic can arrive as GTP-U encapsulated packets containing both outer and inner headers. The outer header can include the gNodeB IP address as the source, while the inner header can include the UE's IP address, which can be used for proper traffic distribution as described below.

The NIC 110 can be communicatively coupled to a set of priority queues 112, which include a high priority queue 114, a medium priority queue 116, and a low priority queue 118. The specific number and priorities of the queues is not intended to be limiting and any number of queues, and any types of priorities, may be used. These queues can be configured to buffer incoming packets based on their assigned priority levels, which may be determined by QoS parameters such as 5G QoS Identifier (5QI) values in uplink traffic or DSCP values in downlink traffic, as discussed more herein. In some implementations, the queues can implement a hierarchical buffering system where packets in higher priority queues receive preferential treatment during network traffic congestion scenarios. Each queue may be implemented with configurable buffer sizes and drop policies to ensure appropriate handling of traffic with different priorities during periods of network congestion.

The UPF 108 further can include a set of worker nodes 120, comprising worker node 122, worker node 124, and worker node 126. These worker nodes can be implemented as processing units that handle packet processing tasks within the UPF 108. Each worker node can maintain session state information for its assigned UEs and implements traffic management functions including bandwidth metering, traffic shaping, and priority-based scheduling. The worker nodes can be implemented as virtual machines, containers, or dedicated hardware processing units, providing flexibility in deployment and scaling.

In some implementations, the worker node can enforce both system-wide and session-specific bandwidth limits. In some implementations, each worker node can maintain separate counters and control mechanisms for different traffic classes and can dynamically adjust processing rates based on configured policies and current network conditions. The worker nodes can also implement the necessary logic to handle network slicing, allowing for isolation and dedicated resource allocation for different services or customer groups.

At its egress, the UPF 108 can include a second NIC 128 that handles traffic over an N6 interface to the data network 130. This NIC 128 can manage the transmission of processed packets from the worker nodes to their ultimate destination in the data network. Like the ingress NIC, it can provide packet handling capabilities including hardware-assisted classification and queuing mechanisms.

In the uplink direction, traffic can flow from the UE 104 through the gNodeB 106 to the UPF's ingress NIC 110. The traffic is then distributed to the appropriate priority queues based on QoS parameters. From the priority queues, packets can be assigned to specific worker nodes using a modified RSS algorithm that ensures consistent UE-to-worker mapping, as discussed in more detail herein. In brief, the modified RSS algorithm can use a 6-tuple hash calculation incorporating the UE's inner IP address and priority information, rather than the existing 5-tuple approach that would lead to suboptimal distribution in a 5G environment.

In the downlink direction, traffic can follow a similar path in reverse, entering through NIC 128 from the data network 130. The packets can again be distributed to priority queues based, in this direction, on their DSCP values and then can be processed by worker nodes according to the same UE-to-worker mapping rules before being transmitted through NIC 110 toward the gNodeB 106 and ultimately to the UE 104. This consistent mapping ensures that all traffic for a given UE, whether uplink or downlink, can be handled by the same worker node, enabling proper enforcement of bandwidth limits and other policies.

As will be discussed in more detail in connection with the following figures, the system can enable efficient handling of traffic with different priority levels while maintaining consistent processing of all traffic for a given UE. This may be particularly important during periods of network traffic congestion, where the system must ensure that high-priority traffic receives preferential treatment while still maintaining fair allocation of resources across all UEs. The use of multiple worker nodes can provide scalability, while the priority queues can ensure QoS requirements are met.

It should be noted that while three priority queues and three worker nodes are shown in the illustrated embodiment, the system may be implemented with more or fewer queues and workers depending on the specific requirements of the deployment. The number of queues may be determined by the range of 5QI values to be supported, while the number of worker nodes can be dynamically adjusted based on traffic load and processing requirements.

In some implementations, the components of the system can be implemented using various combinations of hardware and software. The NICs can include specialized hardware for packet classification and queue management, including dedicated memory for packet buffers and hardware-assisted classification engines. The priority queues can be implemented in memory accessible to both the NICs and worker nodes, with appropriate synchronization mechanisms to ensure thread-safe operation in this multi-threaded environment.

The illustrated system provides a foundation for implementing advanced traffic management features, including network slicing support, guaranteed bit rate enforcement, and dynamic resource allocation, which are described in more detail in subsequent figures. The system is highly scalable and can be deployed in various configurations to meet the needs of different network environments, from small enterprise deployments to large-scale carrier networks.

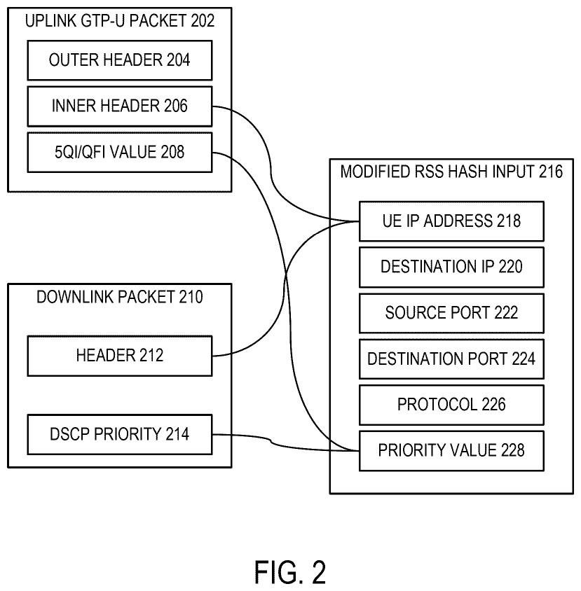

FIG. 2 is a block diagram illustrating packet structures and hash computation inputs according to some of the disclosed embodiments.

The diagram shows three main components: an uplink GTP-U packet structure 202, a downlink packet structure 210, and a modified RSS hash input structure 216 that is used for worker node assignment. Each of these components can be used in the packet processing and distribution system described in connection with FIG. 1 and in the following figures.

The uplink GTP-U Packet 202 represents the structure of packets received from the RAN at the UPF's N3 interface. It contains three main components. First, the outer header 204 can include the source IP address of the transmitting gNodeB and the destination IP address of the receiving UPF. This outer encapsulation can be part of the GTP-U that is used to tunnel user data between RAN and core network elements. The inner header 206 can contain the actual source IP address of the transmitting UE and the destination IP address in the data network. This inner header can represent the actual user traffic being tunneled. Finally, the packet can include a 5QI/QFI value 208, where 5QI represents the Quality of Service class and QoS Flow Identifier (QFI) identifies the specific QoS flow. These values can be used to determine the appropriate priority queue for the packet.

The downlink packet 210 illustrates the structure of packets received from the data network at the UPF's N6 interface. It can contain a header 212 with the source IP address from the data network (DN IP) and the destination IP address of the target UE. Unlike uplink packets, downlink packets may not be GTP-U encapsulated when they arrive at the UPF. The packet can also include a DSCP priority value 214 which is used by the network to indicate the desired priority level for the packet. The DSCP value in the downlink direction can serve a similar purpose to the 5QI/QFI in the uplink direction, helping determine the appropriate priority queue for the packet.

The modified RSS hash input 216 shows the 6-tuple structure used to compute the hash value that determines worker node assignment. This represents a technical improvement over traditional RSS implementations which typically use only 5-tuple structures. The first element is the UE IP address 218, which can be extracted from different locations depending on the traffic direction, namely from the inner header in uplink packets and from the destination header in downlink packets. This can ensure consistent worker assignment for all traffic belonging to a specific UE. The destination IP 220 can be the second element of the tuple, followed by the source port 222 and destination port 224 which help differentiate between different flows for the same UE. The protocol field 226 (e.g., TCP, UDP) can be the fifth element of the tuple.

The sixth and final element is the priority value 228, which can be either the 5QI/QFI value from uplink packets or the DSCP value from downlink packets. This additional tuple element represents a significant technical improvement over traditional RSS implementations, as it allows the system to consider QoS requirements when distributing packets to worker nodes. By ensuring all traffic for a given UE is processed by the same worker node, the system can properly enforce Service Level Agreement (SLA) requirements even under heavy load conditions. This consistent mapping remains stable even as new worker nodes are added to handle increased load, preventing SLA violations that could occur if a UE's traffic were split across multiple worker nodes. This helps ensure that high-priority traffic is handled appropriately even when the system is operating under heavy load.

The diagram further illustrates how fields from the packet structures are mapped to the hash input tuple. Specifically, the UE IP address is extracted from the inner header 206 in uplink packets and from the header 212 in downlink packets. Similarly, the priority value is taken from either the 5QI/QFI value 208 or DSCP priority 214 depending on the traffic direction.

This modified hash computation approach solves several key technical challenges in 5G UPF packet processing. First, it can ensure consistent worker node assignment for all traffic belonging to a specific UE, which is important for maintaining proper bandwidth controls and other per-UE policies. Second, it can avoid the low-entropy problem that would occur if traditional RSS were used on the outer headers of GTP-U packets, where all traffic from a given gNodeB would have the same source IP address. Finally, by incorporating the priority value into the hash computation, it enables more traffic distribution strategies that can take QoS requirements into account.

In some implementations, the system can implement this modified RSS approach using hardware capabilities of the NICs where possible, falling back to software-based computation when necessary. The resulting hash values are used to map packets to specific worker nodes using a consistent hashing algorithm that maintains stability even as worker nodes are added or removed from the system. This can ensure that traffic patterns remain predictable and that per-UE state information remains with the appropriate worker node even as the system scales.

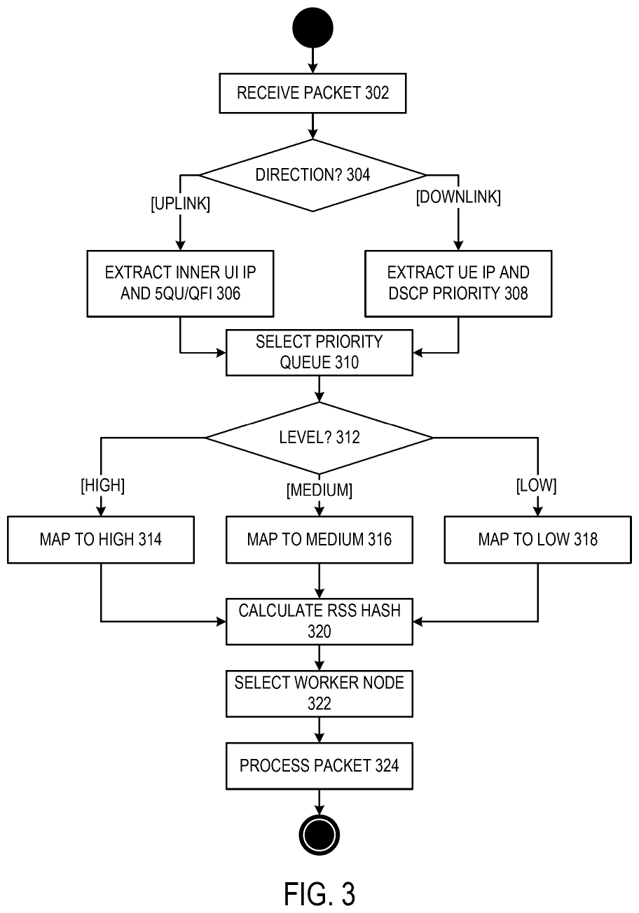

FIG. 3 is a flow diagram illustrating a method for prioritized packet processing and worker node assignment according to some of the disclosed embodiments.

In step 302, the method includes receiving a packet at the UPF. The incoming packet may arrive at either the N3 interface (for uplink traffic) or the N6 interface (for downlink traffic). When a packet arrives, it can be initially buffered in the receiving NIC's memory. The NIC can perform preliminary packet validation, checking for basic integrity and proper formatting according to the relevant protocols.

In some implementations, the step 302 can include performing hardware-assisted packet inspection capabilities within the NIC, allowing for preliminary classification of packets without consuming main processor resources. The NIC can also maintain various packet statistics and counters that can be used for monitoring network conditions and detecting potential congestion situations.

In some implementations, step 302 can also include early packet drop decisions based on buffer occupancy levels and packet priorities. During periods of congestion, the NIC can implement drop policies that preserve high-priority traffic while selectively dropping lower-priority packets according to configured policies.

In step 304, the method can include determining the packet direction by examining the interface on which it was received and the packet headers. For uplink traffic arriving on the N3 interface, packets can be GTP-U encapsulated and contain both outer and inner headers. For downlink traffic arriving on the N6 interface, packets can have a standard IP header structure without GTP-U encapsulation.

The direction determination impacts how subsequent processing steps will extract and interpret priority information and addressing details, as will be discussed. In some implementations, the method can maintain separate processing paths optimized for the unique characteristics of uplink and downlink traffic while ultimately converging on a common worker node selection mechanism.

In some implementations, the determination process includes validation of header formats and protocol versions. For uplink traffic, the method can verify the presence and correctness of GTP-U encapsulation. For downlink traffic, it can validate IP header integrity and ensures proper formatting of QoS marking fields.

In step 306, for uplink traffic, the method can include extracting the inner UE IP address and the 5QI/QFI value from the packet. This step can include parsing the GTP-U encapsulation to access the inner header containing the UE's actual IP address. In some implementations, the 5QI/QFI value can be extracted from the GTP-U extension headers or other associated control information.

In some implementations, the extraction of the inner UE IP address can provide a stable identifier for the traffic source, unlike the outer header's source address which would be the same for all UEs connected to a given gNodeB. In some implementations, the 5QI/QFI value indicates the QoS requirements for the packet and will be used to determine appropriate priority queue assignment.

In some implementations, this extraction process may include validation of the GTP-U header integrity and checking for the presence of required extension headers. The method may also perform additional parsing to extract other relevant QoS parameters that could influence priority queue selection.

The extraction process may include caching mechanisms to store recently seen UE IP addresses and their associated QoS parameters, reducing the processing overhead for subsequent packets from the same UE. This cache may be implemented using hardware-assisted lookup tables in the NIC or in main memory depending on system capabilities.

In step 308, for downlink traffic, the method can include extracting the destination UE IP address and the DSCP priority value from the IP header. The UE IP address in this case can be found in the destination address field of the packet header, while the DSCP value is extracted from the Type of Service (ToS) or Traffic Class field.

The DSCP value can provide QoS information for downlink traffic similar to how 5QI/QFI values function for uplink traffic. This enables consistent priority handling regardless of traffic direction. The method may include DSCP-to-5QI mapping functionality to ensure consistent treatment of traffic across the system.

The extraction process for downlink traffic may include additional validation steps such as checking for DSCP remarking or mapping requirements based on network policies. The method may maintain configurable mapping tables that define how external DSCP markings should be translated into internal priority levels.

In step 310, the method can include selecting a priority queue. In some implementations, this step implements the first part of the two-stage packet processing approach, where packets are initially sorted based on their QoS requirements before worker node assignment occurs.

In some implementations, the method can maintain state information about current queue occupancy levels and can implement one or more congestion management algorithms. This step may also include rate limiting and traffic shaping functionality to ensure fair resource allocation across different priority levels.

In some implementations, the step includes monitoring and feedback mechanisms that can detect and respond to congestion conditions. In some implementations, the step may utilize adaptive thresholds that adjust queue admission policies based on observed traffic patterns and system load levels.

In step 312, the method selects the appropriate priority queue based on the extracted priority information (5QI/QFI or DSCP). This selection process involves mapping the priority values to one of three queue levels: high (step 314), medium (step 316), or low (step 318).

In some implementations, the queue selection algorithm can consider multiple factors beyond just the priority value. It may take into account current queue occupancy levels, historical packet drop rates, and overall system load. The algorithm may implement weighted random early detection (WRED) or similar congestion avoidance mechanisms to proactively manage queue depths.

The mapping of priority values to queues may be configurable and can be adjusted based on operator requirements or network conditions. In some implementations, the mapping may be dynamic, allowing for real-time adjustment based on observed traffic patterns or congestion states.

The selection process may include decision logic that considers multiple QoS parameters simultaneously. For example, it might combine priority information with guaranteed bit rate requirements or latency sensitivity indicators to make optimal queue assignments.

In steps 314, 316, and 318, the packet can be enqueued in the selected priority queue. Each queue can implement its own buffer management policies appropriate for its priority level. For example, high priority queues typically have stricter drop thresholds and may implement mechanisms to prevent head-of-line blocking.

The queuing system may implement buffer sharing mechanisms among the different priority levels to optimize memory utilization while maintaining isolation between priority classes. The queues may also maintain extensive statistics about packet counts, drop rates, and latency measurements.

Each queue may implement its own scheduling policies for dequeuing packets. Higher priority queues may employ strict priority scheduling while lower priority queues might use weighted fair queuing or deficit round robin approaches to ensure fair service.

In step 320, the method calculates a modified RSS hash value using the UE IP address and other packet attributes. This hash calculation represents a significant enhancement over traditional RSS implementations by incorporating both the UE identity and priority information into the worker node selection process.

The hash function can provide good distribution properties while maintaining consistency for packets belonging to the same UE. It considers the full 6-tuple of information including UE IP address, destination IP, source port, destination port, protocol, and priority value. While this 6-tuple approach generates different hash values for different flows from the same UE (due to varying priority values), the system implements a two-stage mapping process. First, the 6-tuple hash is computed to incorporate priority information. Then, a UE-based mapping function ensures all flows from the same UE are directed to the same worker node. This approach preserves QoS awareness while maintaining the critical requirement that all traffic for a UE is processed by a single worker node. The hash algorithm may implement techniques such as symmetric hash functions to ensure consistent worker node selection for both uplink and downlink traffic of all the UE flows.

In some implementations, the hash calculation may be performed using hardware assistance from the NIC, leveraging specialized hashing circuits to accelerate the computation. The method may also implement cache-friendly data structures to optimize the performance of software-based hash calculations when hardware assistance is not available.

The hashing mechanism can include provisions for handling hash collisions and ensuring even distribution of traffic across worker nodes. It may employ techniques such as consistent hashing or rendezvous hashing to maintain stability of assignments when worker nodes are added or removed.

In step 322, the method selects a worker node based on the calculated hash value. The selection process can use hashing techniques to map the hash value to a specific worker node while maintaining stability in the mapping even as worker nodes are added or removed from the system.

The worker node selection algorithm can consider factors such as current worker node load levels and health status. It may implement load balancing mechanisms to ensure even distribution of traffic across available workers while maintaining the crucial requirement that all traffic for a given UE is handled by the same worker.

In some implementations, the method can maintain data structures to track the current worker node assignments and implement mechanisms to handle worker node failure or removal gracefully. It may include capabilities for worker node addition and removal without disrupting existing traffic flows.

In some implementations, the selection process can include failover mechanisms to handle scenarios where a selected worker node becomes unavailable. This may involve maintaining backup assignments or implementing fast rehashing procedures to redistribute affected traffic.

In step 324, the packet is processed by the selected worker node. In some implementations, the worker node can implement the full suite of UPF packet processing functions including packet forwarding, network address translation, traffic policing, and accounting.

In some implementations, the worker node can maintain session state information for all its assigned UEs and implements traffic management functions. This can include enforcement of per-UE bandwidth limits, application of QoS policies, and generation of charging and accounting records.

The processing step may include additional functions such as deep packet inspection, traffic analytics, and performance monitoring. The worker node may also implement various optimization techniques such as batch processing of packets and zero-copy packet handling to maximize throughput.

The worker node can maintain detailed statistics about processed traffic and may implement advanced monitoring capabilities to detect and report anomalies or performance issues. It may also participate in distributed state management protocols to ensure consistency across the worker node cluster.

As illustrated, the method provides an approach to packet processing that ensures consistent handling of UE traffic while maintaining QoS requirements and enabling efficient scaling through multiple worker nodes. The two-stage approach of priority queue selection followed by worker node assignment allows for effective resource management while maintaining the critical requirement of consistent UE-to-worker mapping. The method implements numerous optimizations and safeguards to ensure reliable operation even under challenging network conditions or during system reconfiguration events.

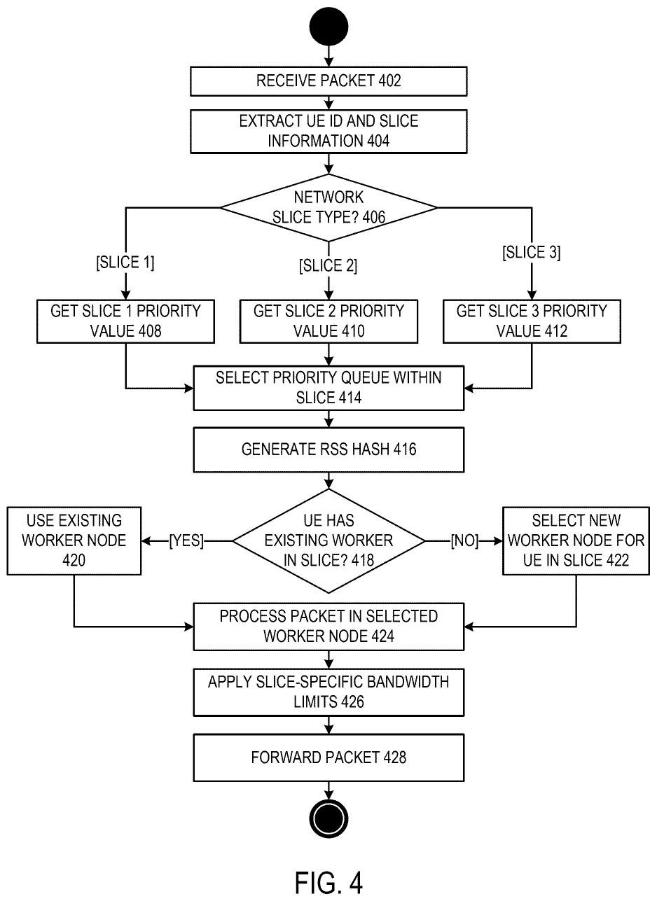

FIG. 4 is a flow diagram illustrating a method for processing packets in a network slicing environment according to some of the disclosed embodiments.

In step 402, the method begins with receiving a packet at the UPF. The packet may arrive on either the N3 interface (for uplink traffic from the RAN) or the N6 interface (for downlink traffic from the data network). Upon reception, the packet can be buffered in the NIC's memory and undergoes initial validation checks.

The packet reception process can include hardware-assisted packet inspection within the NIC to enable rapid preliminary classification. This inspection can include validation of protocol headers, checksums, and basic packet integrity. The NIC can maintain detailed statistics about received packets, including per-slice counters and monitoring metrics.

The reception step may also implement early packet classification to identify the network slice association even before detailed processing begins. This early classification can help optimize memory allocation and buffer management based on slice-specific requirements.

In step 404, the method can include extracting both the UE identifier and network slice information from the packet. For uplink traffic, this can include parsing the GTP-U headers and any extension headers containing slice information. For downlink traffic, slice mapping may be determined through various mechanisms depending on operator implementation and slice configuration. In some implementations, slice association can be determined through deep packet inspection for specific traffic types (e.g., gaming traffic), or through elevated DSCP markings for the differentiated transport handling of high-priority slices such as public safety. However, not all slices may be distinguishable through downlink traffic characteristics alone. The method can support flexible slice mapping configurations that can be customized based on operator-specific slice definitions and classification requirements. For example, an operator implementing only a few distinct slices (such as gaming, public safety, and default) may define clear classification rules, while more complex slice configurations may require additional mapping mechanisms.

The extraction process can include validation of the slice information against configured slice templates in the system. These templates can define the characteristics and requirements of each supported network slice, including QoS parameters, resource allocation policies, and isolation requirements.

The method can maintain a cache of recently seen UE flow-to-slice mappings, as a single UE may simultaneously support multiple flows across different network slices (e.g., up to eight slices per UE in some implementations). While flows may belong to different slices, the method can ensure all flows from the same UE are processed by the same worker node regardless of their slice association. This cache can be synchronized across worker nodes to ensure consistent slice handling throughout the system. The cache maintains the hierarchical relationship between UEs, their flows, and corresponding slice assignments, enabling efficient packet processing while preserving both slice isolation and UE traffic consolidation requirements.

In step 406, the method can include determining the network slice type based on the extracted information. This determination process considers multiple factors including the Single Network Slice Selection Assistance Information (S-NSSAI), slice service type, and any operator-specific slice identifiers.

The slice determination process may consult local configuration databases that define the characteristics and requirements of each supported slice type. These databases can include information about slice priorities, resource allocation policies, and QoS requirements.

In some implementations, the method can implement slice selection logic that can handle scenarios where a UE may be served by multiple slices simultaneously. It maintains state information about active slice associations and ensures proper isolation between different slices.

In steps 408, 410, and 412, the method retrieves the priority value associated with the identified slice type. Each slice may define its own priority scheme and QoS requirements, which are used to influence packet handling decisions.

Like ones configured by operator, the priority value retrieval can include consideration of both static slice priorities and dynamic factors such as current slice utilization levels and service level agreements. The method maintains separate priority schemes for different slices while ensuring fair resource allocation across the system.

The priority determination process may implement hierarchical priority schemes where both slice-level and flow-level priorities are considered. This enables fine-grained control over traffic handling while maintaining slice isolation.

In step 414, the method can include selecting a priority queue within the identified slice based on the retrieved priority value. Each slice can maintain its own set of priority queues to ensure proper traffic isolation and independent resource management.

The queue selection algorithm can consider multiple factors including current queue occupancy levels, historical traffic patterns, and slice-specific QoS requirements. It can implement congestion management mechanisms that operate independently within each slice.

The selection process includes feedback mechanisms that can adapt queue assignment policies based on observed traffic patterns and system conditions while maintaining strict isolation between slices.

In step 416, the method can include generating a modified RSS hash value using the UE identifier while considering the slice context. This hash calculation ensures consistent worker node assignment within each slice while maintaining isolation between slices.

The hash function can implement slice-aware distribution algorithms that ensure even distribution of traffic across worker nodes while respecting slice boundaries. As discussed above, slice association can be determined through various mechanisms depending on the traffic direction and operator implementation. For uplink traffic, slice information is available in GTP-U headers, while downlink traffic may rely on deep packet inspection, DSCP markings, or other operator-defined classification rules for certain slice types such as gaming or public safety. Once slice association is determined, it may employ different distribution strategies for different slice types based on their specific requirements.

In some implementations, the hashing mechanism can include provisions for handling hash collisions and ensuring consistent UE-to-worker mapping within each slice context. It can maintain separate hash spaces for different slices to prevent interference between them.

In step 418, the method can include checking whether the UE already has an assigned worker node within the current slice context. This check can help maintain processing consistency and state management for each UE within its slice.

In some implementations, the lookup process can access a distributed state database that maintains UE-to-worker assignments for each slice. This database can be optimized for fast lookups and includes mechanisms for handling worker node failures or removals.

In some implementations, the method can implement efficient state synchronization mechanisms to ensure consistent UE-to-worker mapping across the system while maintaining slice isolation.

In step 420 and step 422, the method can include either using an existing worker node assignment or selecting a new worker node for the UE within the slice context depending on the decision in step 418. The selection process ensures even distribution of load across available workers while maintaining slice isolation requirements.

The worker node selection algorithm can consider factors such as current worker load levels, resource availability, and slice-specific processing requirements. It implements load balancing mechanisms that operate independently within each slice.

In some implementations, the selection process can include failover mechanisms to handle scenarios where worker nodes become unavailable, ensuring continuous service availability while maintaining slice isolation.

In step 424, the method can include processing the packet in the selected worker node according to slice-specific policies and requirements. Each worker node can maintain separate processing contexts for different slices to ensure proper isolation.

In some implementations, the processing can include slice-specific packet handling rules, QoS enforcement, and traffic management functions. The worker node can maintain separate state information and counters for each slice it handles.

In some implementations, the method can implement resource isolation mechanisms to ensure that processing for one slice does not impact the performance of other slices handled by the same worker.

In step 426, the method can include applying bandwidth limits and other resource constraints at the UPF level based on its proportional share of the overall network slice resources. Since, in some scenarios, a network slice can span multiple gNodeBs and UPFs, each UPF generally manages only its allocated portion of the total slice resources. The UPF can implement bandwidth controls and resource constraints proportional to its scope within the broader slice architecture, while coordinating with other network functions to maintain overall slice SLA and isolation between different slices. For example, if a slice is allocated 20% of total network resources, each UPF handling traffic for that slice will manage its local resources to maintain that proportional allocation within its scope of operation.

In some implementations, the bandwidth control mechanisms can implement hierarchical policies that consider both slice-level and individual UE-level limits. In some implementations, the method can maintain separate accounting and enforcement mechanisms for each slice.

The control process can include dynamic adjustment capabilities that can adapt bandwidth allocations based on current conditions while maintaining slice isolation guarantees.

In step 428, the method can include forwarding the processed packet toward its destination. In some implementations, the forwarding process can implement slice-specific routing policies and maintains isolation between different slice traffic.

In some implementations, the forwarding step can include detailed logging and monitoring to track slice performance metrics and ensure compliance with service level agreements. It maintains separate forwarding statistics for each slice.

In some implementations, the method can implement packet marking and encapsulation mechanisms based on traffic direction. For uplink traffic, the method preserves the 5QI/QFI values in GTP-U encapsulation to maintain slice context. For downlink traffic, where slice identification may be derived from DSCP markings for certain slice types (such as high-priority slices), the method maintains these DSCP values. Additional slice context may be maintained through operator-specific mechanisms depending on how slices are implemented and identified in the network. This ensures that available slice identification information remains intact as packets traverse the network.

The illustrated method provides a comprehensive approach to handling network slicing requirements while maintaining efficient packet processing capabilities. It ensures proper isolation between slices while enabling flexible resource allocation and management policies. The method implements numerous optimizations and safeguards to ensure reliable operation in a multi-slice environment.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data.

Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or NIC.

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, a packet at a user plane function (UPF);
extracting, by the processor, a UE identifier and a priority value from the packet;
selecting, by the processor, a priority queue from a plurality of priority queues based on the priority value;
generating, by the processor, a hash value using at least the UE identifier and the priority value;
selecting, by the processor, a worker node from a plurality of worker nodes based on the hash value; and
processing, by the processor, the packet at the worker node.

2. The method of claim 1, further comprising:
receiving an uplink packet encapsulated according to GPRS Tunneling Protocol User Plane (GTP-U);
extracting the UE identifier from an inner IP header of the GTP-U encapsulated uplink packet; and
extracting the priority value comprising a 5G QoS Identifier (5QI) value and Quality of Service Flow Identifier (QFI) from GTP-U extension headers of the uplink packet.

3. The method of claim 1,
receiving a downlink packet;
extracting the UE identifier from a destination address field of the downlink packet; and
extracting the priority value comprising a Differentiated Services Code Point (DSCP) value from a Type of Service field of the downlink packet.

4. The method of claim 1, wherein generating the hash value comprises:
generating a hash input comprising one of a 5-tuple hash input or a 6-tuple hash input, the 5-tuple hash input comprising the UE identifier, a destination IP address, a source port, a destination port, and a protocol identifier, and the 6-tuple hash input comprising the UE identifier, a destination IP address, a source port, a destination port, a protocol identifier, and the priority value; and
computing the hash value based on the hash input.

5. The method of claim 1, further comprising:
determining that the packet is associated with a network slice;
identifying slice-specific requirements for the network slice; and
applying the slice-specific requirements when processing the packet at the worker node.

6. The method of claim 1, further comprising:
determining whether a previously assigned worker node exists for the UE identifier;
when the previously assigned worker node exists, selecting the previously assigned worker node as the worker node; and
when no previously assigned worker node exists, selecting a new worker node as the worker node.

7. The method of claim 1, further comprising:
maintaining a mapping between UE identifiers and worker nodes;
tracking bandwidth usage for each UE at each worker node; and
enforcing bandwidth limits for each UE at the worker node.

8. A non-transitory computer-readable storage medium for tangibly storing computer program instructions capable of being executed by a computer processor, the computer program instructions defining steps of:
receiving a packet at a user plane function (UPF);
extracting a UE identifier and a priority value from the packet;
selecting a priority queue from a plurality of priority queues based on the priority value;
generating a hash value using at least the UE identifier and the priority value;
selecting a worker node from a plurality of worker nodes based on the hash value; and
processing the packet at the worker node.

9. The non-transitory computer-readable storage medium of claim 8, the steps further including:
receiving an uplink packet encapsulated according to GPRS Tunneling Protocol User Plane (GTP-U);
extracting the UE identifier from an inner IP header of the GTP-U encapsulated uplink packet; and
extracting the priority value comprising a 5G QoS Identifier (5QI) value and Quality of Service Flow Identifier (QFI) from GTP-U extension headers of the uplink packet.

10. The non-transitory computer-readable storage medium of claim 8, the steps further including:
receiving a downlink packet;
extracting the UE identifier from a destination address field of the downlink packet; and
extracting the priority value comprising a Differentiated Services Code Point (DSCP) value from a Type of Service field of the downlink packet.

11. The non-transitory computer-readable storage medium of claim 8, wherein generating the hash value comprises:
generating a hash input comprising one of a 5-tuple hash input or a 6-tuple hash input, the 5-tuple hash input comprising the UE identifier, a destination IP address, a source port, a destination port, and a protocol identifier, and the 6-tuple hash input comprising the UE identifier, a destination IP address, a source port, a destination port, a protocol identifier, and the priority value; and
computing the hash value based on the hash input.

12. The non-transitory computer-readable storage medium of claim 8, the steps further comprising:
determining that the packet is associated with a network slice;
identifying slice-specific requirements for the network slice; and
applying the slice-specific requirements when processing the packet at the worker node.

13. The non-transitory computer-readable storage medium of claim 8, the steps further comprising:
determining whether a previously assigned worker node exists for the UE identifier;
when the previously assigned worker node exists, selecting the previously assigned worker node as the worker node; and
when no previously assigned worker node exists, selecting a new worker node as the worker node.

14. The non-transitory computer-readable storage medium of claim 8, the steps further comprising:
maintaining a mapping between UE identifiers and worker nodes; tracking bandwidth usage for each UE at each worker node; and enforcing bandwidth limits for each UE at the worker node.

15. A device comprising:
a processor configured to:
receive a packet at a user plane function (UPF);
extract a UE identifier and a priority value from the packet;
select a priority queue from a plurality of priority queues based on the priority value;
generate a hash value using at least the UE identifier and the priority value;
select a worker node from a plurality of worker nodes based on the hash value; and
process the packet at the worker node.

16. The device of claim 15, wherein the processor is further configured to receive an uplink packet encapsulated according to GPRS Tunneling Protocol User Plane (GTP-U);
extract the UE identifier from an inner IP header of the GTP-U encapsulated uplink packet; and
extract the priority value comprising a 5G QoS Identifier (5QI) value and Quality of Service Flow Identifier (QFI) from GTP-U extension headers of the uplink packet.

17. The device of claim 15, wherein the processor is further configured to:
receive a downlink packet;
extract the UE identifier from a destination address field of the downlink packet; and
extract the priority value comprising a Differentiated Services Code Point (DSCP) value from a Type of Service field of the downlink packet.

18. The device of claim 15, wherein generating the hash value comprises:
generating a hash input comprising one of a 5-tuple hash input or a 6-tuple hash input, the 5-tuple hash input comprising the UE identifier, a destination IP address, a source port, a destination port, and a protocol identifier, and the 6-tuple hash input comprising the UE identifier, a destination IP address, a source port, a destination port, a protocol identifier, and the priority value; and
computing the hash value based on the hash input.

19. The device of claim 15, the processor further configured to:
determine that the packet is associated with a network slice;
identify slice-specific requirements for the network slice; and
apply the slice-specific requirements when processing the packet at the worker node.

20. The device of claim 15, the processor further configured to:
determine whether a previously assigned worker node exists for the UE identifier;
when the previously assigned worker node exists, select the previously assigned worker node as the worker node; and
when no previously assigned worker node exists, select a new worker node as the worker node.
